(19) United States
(12) Patent Application Publication
(10) Pub. No.: US 2009/0133843 A1
(43) Pub. Date: May 28, 2009

(54) COVER SYSTEM WITH SUPPORT MEANS AND SNAP-TOP DECORATIVE CAP

(76) Inventors: Kelly J. Ragsdale, Salt Lake City, UT (US); LaMont Drechsel, Salt Lake City, UT (US); Nathan Dewyea, Salt Lake City, UT (US); W. Leroy Eash, Lutz, FL (US)

Correspondence Address: HOLME ROBERTS & OWEN, LLP, 299 SOUTH MAIN, SUITE 1800, SALT LAKE CITY, UT, 84111, US

(21) Appl. No.: 11/944,619

(22) Filed: Nov. 24, 2007

(51) Int. Cl. E06B 9/56

(52) U.S. Cl. 160/272

(57) ABSTRACT

A track system for use with a cover positionable over a space, which includes a first and second track positioned proximate the space. The first and second tracks each include a slot extending the length of the track, and is configured for slidably receiving an outside edge of the cover. The track system includes first and second trolleys each having a slide for positioning in and configured for movement in their corresponding slot. Each trolley having support means for contact with a support surface to support the corresponding trolley. The support means is configured to facilitate movement of the trolley relative to a corresponding track. The track system also includes a leading edge support for connection to and between both trolleys, and is configured to have a leading edge of the cover attached thereto. The leading edge support being movable with both trolleys to between a first position in which the cover is positioned toward covering the space and a second position different from the first position and toward uncovering the space.

### BACKGROUND OF THE INVENTION

1. Field of Invention

The present invention relates to systems for positioning a cover over a space and more particularly to an improved track system operating with reduced friction as the cover is extended and closed and including hidden fasteners for attaching to a surface.

2. The Relevant Technology

Swimming pools are often covered when not in use for reasons which include restricting access, limiting evaporation of water and chemicals, retaining heat and acting as a barrier to leaves, twigs and similar kinds of material. Other spaces such as ponds and other kinds of pools may also be covered from time to time for similar reasons.

A wide variety of covers are available to cover such spaces. For example, covers for swimming pools include both manual covers that are manually positioned, opened and fastened, automatic covers that are operated between open and closed configurations by an electric or hydraulic motor drive mechanism, and semiautomatic mechanisms that may be automatic in one direction and manual in the other direction. U.S. Pat. No. 3,050,743 (Lamb) discloses an early automatic cover typically used with swimming pools. A more recent version of an automatic cover is disclosed in U.S. Pat. No. 4,858,253 (Lamb). An even more recent version is disclosed in U.S. Pat. No. 6,769,142 (Ragsdale, et al.)

The '253 patent shows an automatic cover system with tracks along two opposite edges of the pool. The tracks guide the edges of the cover and guide the ropes which extend outwardly from the leading edge around pulleys and back to reels. A motor is connected through a clutch to drive the drum to wind the cover to the open position and to drive reels that pull in the ropes to urge the cover to the closed position. The reels are positioned in a housing which has pulleys to guide the ropes from the tracks to the reels. In the '142 patent, the ropes have been eliminated while the cover edge has beads that are driven through the track.

In any configuration, the outside edges of the cover sometimes encounter resistance as they slide in their respective grooves, both when opening and closing. That is, corrosion, dirt, dimensional variance or a host of other factors, separately or in some combination, may restrict the movement of one or the other or both outside edges of the cover in its respective slot. In turn, the effort to close or open for manual systems and the force necessary to operate automatic systems is notably increased. The greater force may also cause damage to the cover itself. Thus ways to facilitate movement of the cover and reduce friction or drag as the cover is operated are desirable.

In operation, covers have been observed moving in a jerking or intermittent fashion along one or both edges as the edge encounters different points of high friction along the length of the track. The friction may be due to the previously described factors, such as the accumulation of dirt and debris within the slot of the track, or oxidation of the metal surrounding the slot of the track. As a result, in some cases, one edge of a cover may move farther that the other edge so that the cover may become cocked or misaligned to other than normal or generally perpendicular orientation to and between two substantially parallel tracks and in turn jammed in place.

Additionally, the track of a cover system is typically positioned next to a space to be covered. For example, the track may be fastened to the deck of a pool using screws or bolts that are driven through an exposed top surface of the track. However, the tops of the screws or bolts may protrude from the exposed top surface of the track, or the screws or bolts may degrade over time revealing burrs, both of which pose a potential risk of foot injury when walking across the track. Also, the visible tops of the screws or bolts may be unsightly as they break up the continuous and smooth outline of the exposed surface of the track.

### SUMMARY OF THE INVENTION

A system for extending and retrieving a cover relative to a space to be covered has a cover shaped and sized for positioning between a closed position substantially covering the space to be covered and an open position displaced from the closed position and preferably substantially removed from the space to be covered. A space to be covered is any void or volume with an exposed surface such as a swimming pool, pond or other similar void or volume with an exposed surface. The cover has a front edge and a first outside edge spaced from a second outside edge.

A first track is spaced from a second track. Both the first track and the second track are positioned proximate the exposed surface of the space to be covered, where the second track is in alignment with the first track. Both the first track and the second track are configured to guide their respective first and second outside edges of the cover upon movement of the cover relative to the space to be covered. Specifically, the first track and the second track includes a first slot and second slot respectively, both of which extend the length of their respective track and are configured for slidably receiving a respective outside edge of the cover. Both the first track and the second track also have a first end and a second end spaced from the first end.

The system also includes a first trolley and a second trolley each for positioning and configured for movement in the first slot and the second slot, respectively. The first trolley further includes a first support means for contact with a first support surface on the first track to support the first trolley. The second trolley similarly includes a second support means for contact with a second support surface on the second track to support the second trolley. The first support means is configured to facilitate movement of the first trolley relative to the first track. The second support means is configured to facilitate movement of the second trolley relative to the second track.

Additionally, the system also includes a leading edge support for connection to and between the first trolley and the second trolley. The leading edge support is configured to have a leading edge of the cover attached thereto to facilitate movement of the cover upon movement of the first trolley and the second trolley. Specifically, the leading edge support is moveable with the first trolley and the second trolley between a first position in which the cover is positioned toward covering the space and a second position different from the first position and toward uncovering the space.

In addition, both the first track and the second track include an opposing slot that is laterally spaced from respective first and second slots that are configured for slidably receiving outside edges of the cover. Each of the opposing slots extends the length of the track and is configured to return rope means associated with the outside edge of the cover. For example, the first track includes a first opposing slot that is laterally spaced from the first slot and is configured to return rope means being guided to a driving means used for extending and retrieving the cover. A trough is configured between the first slot and first opposing slot, wherein the trough extends the length of the first track and is further configured to receive means for attaching the first track to a first walking surface. A cover piece is removably positioned over the trough and also extends the length of the track.

### BRIEF DESCRIPTION OF THE DRAWINGS

Exemplary embodiments are illustrated in referenced figures of the drawings which illustrate what are regarded as the preferred embodiments presently contemplated. It is intended that the embodiments and figures disclosed herein are to be considered illustrative rather than limiting.

FIG. 1 is a perspective cut-away view of a cover system of the present invention.

FIG. 2 is a partial cut-away perspective of portions of the track and guide means for use with a system of the present invention.

FIG. 3 illustrates partial perspective cut-away views of the track with related components positioned in a spaced relationship, in accordance with one embodiment of the present invention.

FIG. 4 is a cross-sectional side depiction of an improved track including a hidden trough for placement of means for attaching and a lip portion for reducing friction, in accordance with one embodiment of the present invention.

FIG. 5 is a side view depiction of a cover bar attachment and trolley for attaching the leading edge of a cover to a track, in accordance with one embodiment of the present invention.

FIG. 6 is a front view depiction of the cover bar attachment and trolley of FIG. 5 for attaching the leading edge of a cover to a track, in accordance with one embodiment of the present invention.

FIG. 7 is a top view depiction of the cover bar attachment and trolley of FIG. 5 for attaching the leading edge of a cover to a track, in accordance with one embodiment of the present invention.

FIG. 8 side view depiction of the cover bar attachment and track illustrating their spatial relationship, in accordance with one embodiment of the present invention.

FIG. 9 is closer cross sectional side view depiction of the slide attached to the trolley within a slot of a track, in accordance with one embodiment of the present invention.

### DETAILED DESCRIPTION OF THE PREFERRED EMBODIMENTS

Reference will now be made in detail to the preferred embodiments of the present invention. The figures illustrate a cover system operating with reduced friction when extending and closing the cover, and a track system including a snap-top decorative cap hiding a trough for fastening the track to a surface. While the invention will be described in conjunction with a cover operated using ropes and pulleys to move the cover from the open position toward a closed position, it should be understood that the principles herein discussed are equally applicable to covers that are manually pulled through tracks over openings such as pools and spas as well as covers that are automatically operated but without a rope such as in a cover system as disclosed in U.S. Pat. No. 6,769,142 (Ragsdale, et al.)

It should also be understood that the preferred embodiments, are not intended to limit the invention. On the contrary, the invention is intended to cover alternatives, modifications and equivalents which may be included within the spirit and scope of the invention as defined by the appended claims.

Accordingly, embodiments of the present invention provide for a cover system that does not jam and that does not skip or jump along the track. Other embodiments are well suited to the above improvements and further provide for a cover system that does not lead to a cocked or misaligned orientation and does not require servicing to realign to keep the cover with its leading edge oriented generally normal to the tracks. Still other embodiments are well suited to the above improvements and further provide for a track that is visibly pleasing and safe, since the track does not show protrusions on the exposed top cover of the track.

Cover System

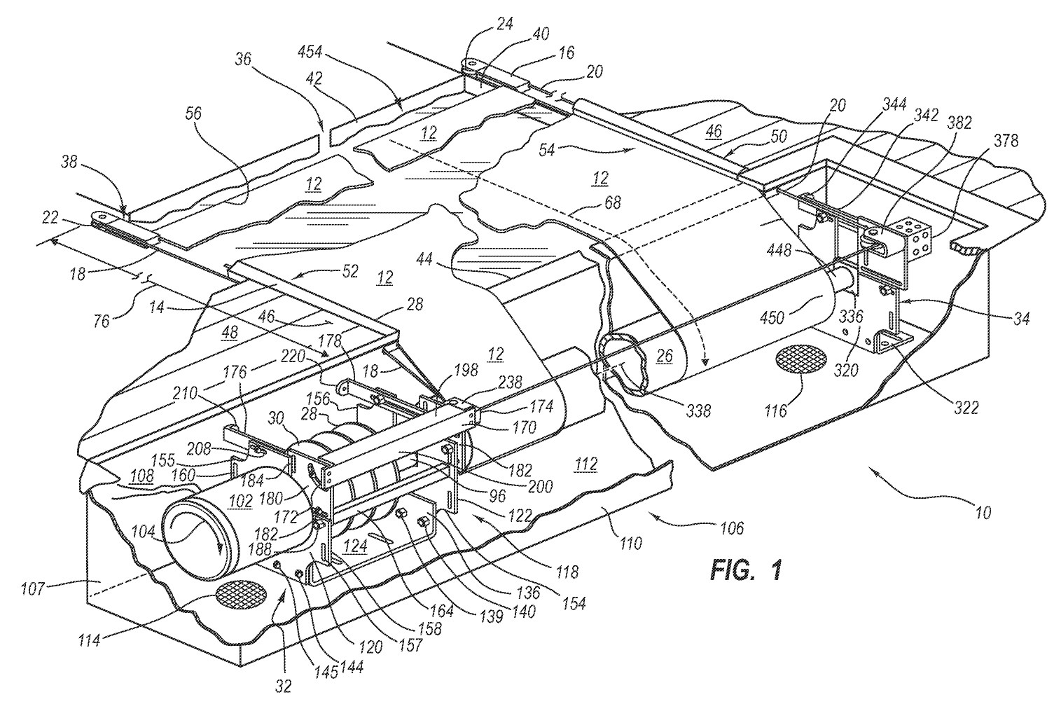

A system 10 for extending and retrieving a cover generally includes a cover 12, first track 14 and second track 16, first rope 18 and second rope 20, first guide 22 and second guide 24, drum 26, first reel 28 and second reel 30, drive means 32 and support means 34. The system 10 is operable to position the cover 12 between a closed position in which the cover is positioned over a space to be covered and an open position in which the cover 12 is displaced from the closed position and preferably is positioned to substantially uncover the space to be covered. As stated hereinbefore, the space to be covered may be any void or volume having a surface that one desires to cover and uncover. As here shown, the space to be covered is a swimming pool 36. The cover 12 of FIG. 1 is shown almost, but not fully, in the closed position.

The swimming pool 36 illustrated is generally rectangular in projection with a first side wall 38, a second side wall 40 and a front wall 42. A rear wall is under the illustrated cover sill 44 and in turn is not illustrated. The swimming pool 36 has a deck or walking surface 46 that surrounds the swimming pool 36 with the first track 14 and the second track 16 shown mounted on top or on the walking surface 46 proximate the swimming pool 36. That is, the first track 14 and the second track 16 are here shown positioned close to and in alignment with the first edge 48 and the second edge 50 of the swimming pool 36. The first track 14 and the second track 16 are essentially parallel. However, it must be understood that the swimming pool 36 is only representative of virtually an infinite array of swimming pools or other voids, volumes or spaces which may be made in or come in virtually any shape or size (in projection). For example, the space to be covered includes, but is not limited to, oval pools, kidney-shaped pools, elliptical pools, oblong ponds, recessed spas, and tiered or terraced pools.

With the first track 14 and the second track 16 mounted on the walking surface 46, a cover similar to cover 12 can be made to cover a wide range of shaped openings or spaces which one may wish to removably cover. The first track 14 and the second track 16 may also be mounted under a cantilevered edge or portion extending toward and into the space to be covered. In short, the space to be covered may have a lip with a first track and a second track mounted thereunder as discussed hereinafter.

The cover 12, as illustrated, has a first edge 52 and a second edge 54 that is spaced from and in general alignment with the first edge 52. The first edge 52 and the second edge 54 are shown to be parallel in the illustrated embodiment. The cover 12 also has a front edge 56 plus a rear edge that is not shown. The rear edge is mounted to and preferably attached to the drum 26. However, the rear edge is not illustrated for purposes of clarity.

The cover 12 is made from any suitable fabric including preferably a 16-ounce vinyl material reinforced with a strong polyester mesh to increase strength and tear resistance.

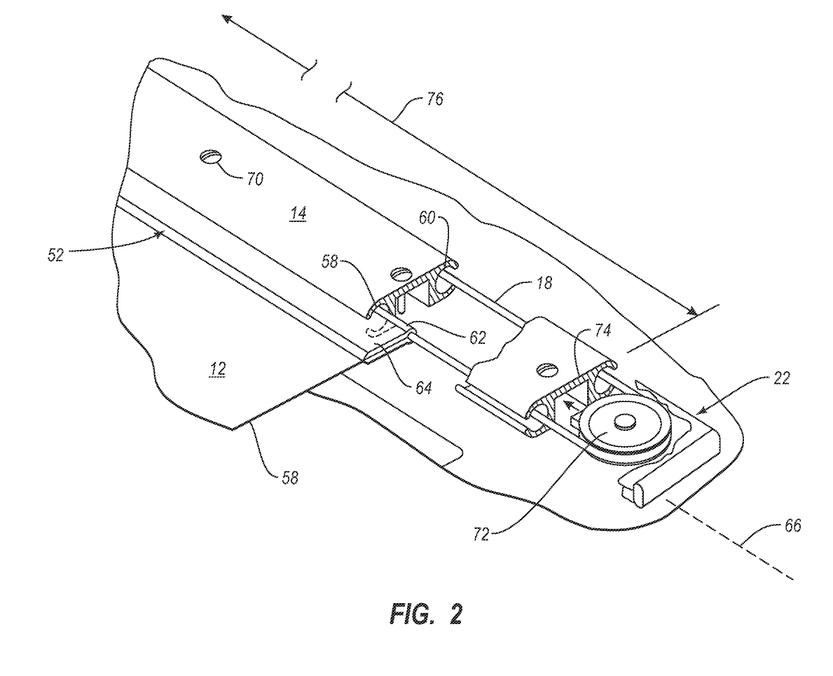

The first track 14 and the second track 16 are provided to act as a guide for the first edge 52 and the second edge 54 of the cover 12 and are generally parallel to each other. The track 14 is better illustrated in FIG. 2 to have a cover slot 58. The cover slot 58 receives the first edge 52 of the cover 12 to guide the first edge 52 in its travel between its open position in which it is retracted or wound upon the drum 26 and the closed position in which it is fully extended across the space to be covered. The cover slot 58 also supports the cover 12 because the first edge 52 has a bead 62 formed by folding the cover over the first rope 18 (or first line). That is, the bead 62 may be formed along the entire length 68 of the cover 12 by stitching a folded portion 64 to the cover 12 with the rope therein at the edge 52 along the entire length 68 (FIG. 1) of the cover 12. Additional stiffeners or gussets may be used to form the bead 62 as well to strengthen the edge 52.

The cover slot 58 is sized in cross section normal to its longitudinal axis 66 to slidingly receive the first edge 52, and more particularly the bead 62, to retain the cover 12 in a fixed position along the entire length 68 of the track 14. The track 14 may be held in place by suitable fasteners such as screws 70. Of course, expansion bolts, glue or any other kind of fastening material or device can be used as desired so long as the track 14 provides a secure mounting for the cover 12.

The first rope 18 is stitched into the edge 52 of the cover 12 and extends therefrom through the cover slot 58 to the first guide means which is shown in FIG. 2 as a pulley mechanism 72 inserted into the distal or first end 74 of the first track 14. The first rope 18 is trained around the pulley mechanism 72 and directed into the rope slot 60. The first rope 18 extends through the rope slot 60 along the length 76 of the first track 14 to the proximal or second end 78 of the first track 14. Thereafter the first rope 18 is directed through pulleys to the first reel 28, as more fully discussed hereinafter. It should be noted that pulley 72 is here depicted as a guide means. Other forms of guide means may be used including a rounded post, a roller or other structure suitable for changing direction in a general, low friction arrangement.

The first track 14 and the second track 16 are both shown mounted to the walking surface 46 and in turn are exposed. For some spaces, including pools with an overhang or lip, the track may be installed under the overhang or lip to recess the track, to enhance the esthetic appearance and to remove the track from underfoot, in accordance with embodiments of the present invention.

The second track 16 with the second rope 20, the second guide 24 and the second edge 54 of the cover 12 are all configured and assembled substantially as shown and described for the first track 14, first guide 22, first rope 18 and first edge 52. The second track 16 and the second edge 54 structure are not here further described in detail for brevity because they are configured and formed virtually the same as the first track 12 and first edge 52 except for those changes necessary for placement on the opposite side.

In the prior art, ropes have been used to extend from the front edge of a cover such as front edge 56 of cover 12 so the cover may be opened by placing a tension on the ropes. Such ropes in the prior art are shown trained around a pulley or the like at the end of their tracks and returned to reels. Such ropes have been sized to be longer than double the length 76 of the track 14 plus the distance from the distal end 74 to the reel such as reel 28. With the ropes so sized, several revolutions (4 or 5 typically) of the rope are generally positioned about the hub of the reel to allow for errors in measurement and installation and to absorb the additional length. Further, the ropes of the prior art are somewhat elastic and may stretch depending on the nature and type of rope (e.g., nylon, hemp, cotton and hybrids) employed (e.g., as much as 17% of its length upon the generation of significant force such as, for example 150 lbs.). Thus one or both of the ropes stretch some to reduce the risk of damage to the rope or the cover should one or both sides of the cover jam or stick in its respective track upon movement toward the closed position or toward the open position.

Additional components, such as reels for controlling the rope, the drum 26 that is operated to wind the cover 12 thereupon, the motor 102, etc. are described in more detail in U.S. Pat. No. 5,920,922 (Ragsdale et al.) disclosing a cover system for extending and retrieving a cover, which is hereby incorporated in its entirety. In summary, upon operation of the reels 28 and 30 by the motor 102, the ropes 18 and 20 are tensioned to draw the cover 12 from the drum 26. The drum 26 is then freely rotating so that the cover 12 will pay out and cover the space to be covered such as the entire pool 36. Of course it should be understood that a manual cover may be operable without a rope reel. Also cover systems that do not employ ropes such as that seen in U.S. Pat. No. 6,769,142 (Ragsdale, et al.) nonetheless can jam the same as if it had ropes.

Improved Track System

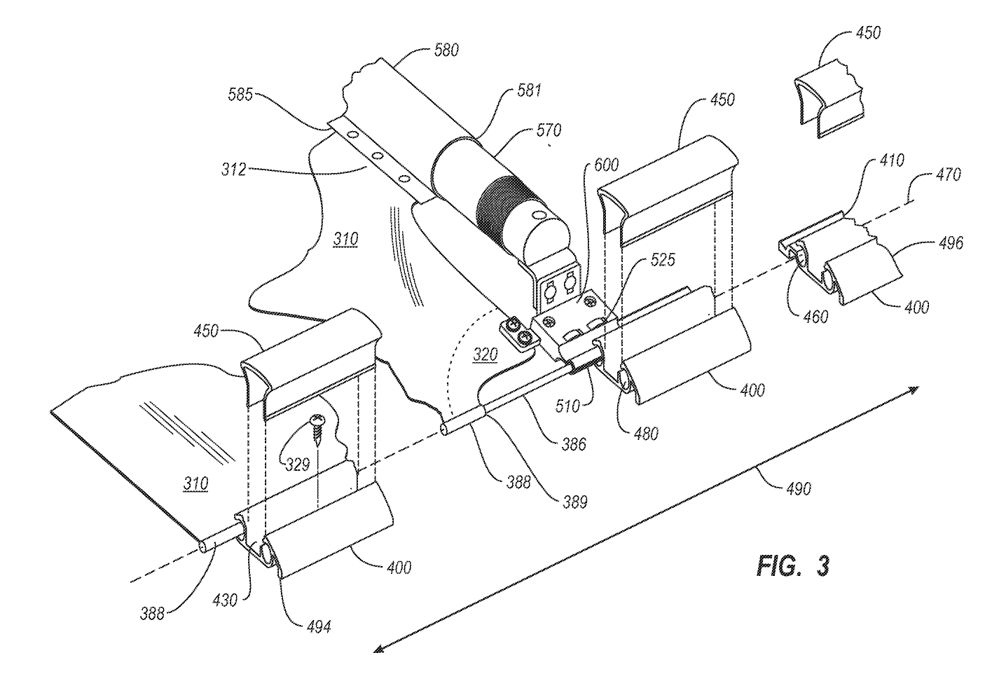

Turning now to FIG. 3, cut-away perspective views of a cover system are shown illustrating an improved track 400 that reduces friction in the track when extending and retrieving a cover 310. The cover system in FIG. 3 is shown positionable over a space. As shown, track 400 is shown in relation to the middle portion of cover 310, in relation to a the leading edge 312 of cover 310, and in a position near the end 496 of track 400 which exposes a cross section of track 400.

In addition, cover 310 includes a leading edge 312 plus a rear edge that is not shown. The rear edge is mounted to and preferably attached to the drum that winds up and pays out cover 310 as it is extended or retrieved. As shown, the leading edge 312 of cover 310 is positioned or attached to a leading edge support 580 through any suitable means. For example, as shown, leading edge 312 can be attached to strip 585 extending from leading edge support 315 through stitching, tacking, bolting, or any other alternative methods. To enclose the space, the leading edge 312 of cover 310 as aided by the leading edge support 580 is brought in a direction towards the end of track 496 to fully extend the cover over the space. Conversely, to expose the space the leading edge 312 of cover 310 as aided by the leading edge support 580 is led back away from track end 496 so that the cover 310 is wound upon the drum.

The leading edge support 580 provides stiff lateral support to the leading edge 312 of cover 310. That is, leading edge support 580 extends between the two parallel tracks that are each positioned proximately around the space to be covered. As shown, the leading edge support 580 is formed as a cylindrical sleeve, or bar that is at least hollow at both ends, including end 581. As shown, support extension 570 may be inserted into the end 581 and is adjustable to connect the leading edge support 580 to the rope 386 positioned in track 400 through the trolley 600 through various components including support extension 570, trolley 600, and slide 510 which is firmly affixed to rope 386 and slidingly received by slot 460. In other embodiments, support extension may be fastened to leading edge support 460 using any suitable means, such as screwing bolting, gluing, etc. The leading edge support 460 is moveable with trolley 600 and an opposing trolley associated with an opposing track to between a first position in which cover 310 is positioned toward covering the space, and a second position different from the first position and toward uncovering the space. In other embodiments, the leading edge support 580 extends directly between the two tracks without the use of support extension 570 and may be attached directly to a trolley 600 on both ends of the leading edge support 580.

Being constructed of rigid material, the leading edge support 580 acts to pull the leading edge 312 of the cover 310 away from the space, or more particularly, away from a horizontal plane defined by the two parallel tracks. In the case where the space to be covered is a pool, the leading edge support 580 acts to lift the leading edge 312 of cover 310 away from the surface of the water in the pool. As such, surface tension from the water acting to pull the cover 312 down towards the water is reduced, especially as the cover is being extended over the pool. In one implementation, the leading edge support 580 may include a substantially straight tubular member extending between the trolleys connected to the two parallel tracks. Other embodiments are well suited to a leading edge support 580 that is a bowed tubular member that is curved away from the space, or in the case of a pool away from the surface of the pool. Still other embodiments contemplate various shapes for the leading edge support 580 that are capable of functioning to provide support to the leading edge 312 of cover 310.

The cover 310, as illustrated, has an outside edge 388 that is positioned to be guided by track 400. Specifically, outside edge 388 is analogous to the bead 62 (FIG. 2), and can be formed by folding and stitching the cover 310 over the rope 386 through the entire length 490 of cover 310. Outside edge 388 is positioned to be received by track 400 and slides along track 400 as the cover is extended and retrieved over the space to be covered. The outside edge 388 includes an end 389 that is near the leading edge 312 of cover 310. Specifically, cover 310 includes a corner 320 that receives end 389. To avoid any weakness at the transition from outside edge 388 to rope 386 at end 389 due in part to the weight of the cover 310, or due possibly to surface tension of water in the pool to be covered, corner 320 may be reinforced with additional material, stitching, gussets or other alternate reinforcing structure. In addition, corner 320 is shown attached to the trolley 600 of the present invention to reduce the forces on the outside edge 388 at end 389.

Desirably, track 400 is formed in a continuous length 490 that is equal to or greater than a length of the space to be covered. However, the track is typically provided in standard lengths to facilitate transportation and installation.

As described previously, track 400 is positioned proximate the space to be covered and is provided to act as a guide to facilitate movement of the outside edge 388 along the track 400 as the cover is extended and retrieved over the space to be covered. Track 400 includes a slot 460 that extends the length 490. The slot is configured for slidingly receiving outside edge 388 of cover 310. As shown, slot 460 includes a central axis 470 that is substantially linear throughout the length 490 of track 400. As such, track 400 is typically attached to the surface surrounding the space to be covered in a straight line.

Although not shown, an opposing track is typically located on the opposite side of the space to be covered. The opposing track is also attached to the surface surrounding the space to be covered, and is attached in a straight line that is parallel to track 400. The opposing track and the associated structures attached thereto are not here further described in detail for brevity because they are configured and formed virtually the same as track 400 and the associated structures attached thereto, except for those changes necessary for placement on the opposite side of the space to be covered.

In particular, slot 460 in track 400 is also configured for slidingly receiving trolley 600. As shown, on one side trolley 600 is attached to leading edge support 580 through support extension 570, and on the other side trolley 600 is slidably received by track 400 through a slide 510. In that way, the leading edge 312 of cover 310 is connected to the slide 510 through the leading edge support 580, the support extension 570, trolley 600 and slide 510. In particular, slide 510 is fixedly attached to rope 386 and moves along the slot 460 as the rope is pulled through the slot 460 in either direction. As such, since the leading edge support is attached to trolley 600 which is attached to the leading edge support 580, as the slide moves along slot 460, the leading edge 312 of cover 310 is also moved in relation to track 400 to extend or retrieve cover 310 over the space.

In a preferred embodiment, trolley 600 acts to reduce the friction experienced when extending or retrieving cover 310. Specifically, the slide 510 acts to keep the alignment between trolley 600 and track 400 relatively constant as the trolley 600 moves along the track 400 with the movement of rope 386. In particular, slide 510 acts to restrict the lateral pulling of rope 386 out of the slot 460 due to the cocking or misalignment of the leading edge 312 of the cover 310 as it is being extended or retrieved. As such, slide 510 keeps trolley 600 in relatively constant longitudinal alignment with track 400, which facilitates longitudinal movement of trolley 600 along track 400 with the movement of rope 386. In addition, this constant alignment helps maintain the leading edge 312 of cover 310 generally in a perpendicular orientation to and between the parallel tracks.

Track 400 may be constructed from any durable material such as metals or plastics. Because many spaces to be covered are swimming pools that have a high chlorine content, many materials will easily and readily corrode. Typically, the track 400 is made out of non-corrosive material. Aluminum or alloys of aluminum are typical because they are relatively easy to extrude, light weight and relatively low cost and yet sufficiently rigid but easy to work with as compared to, for example, alloys of steel such as stainless steel.

The track 400 may be held in place by suitable fasteners such as screw 329. Of course, expansion bolts, glue, or any other kind of fastening material or device can be used as described so long as the track 400 is securely fastened to the surface surrounding the space to be covered. Screw 329 is shown fastened within trough 430. By configuring track 400 to include trough 430 and an interlocking decorative cap 450 that covers trough 430, the screw 329 is hidden. As such, the tops of screw 329 or the burrs resulting from fastening screw 329 to the surface surrounding the space through the track 400 will also be visibly and physically hidden.

Track 400 includes two ends. The first end 496 is the end to which a guide comparable to guide 22 is attached. A pulley such as pulley 74 (FIG. 2) is preferable as a guide. The second end 494 of the track 400 is the end opposite the first end 496 and is positioned toward the drum of the system which is not here shown but which is comparable to drum 26.

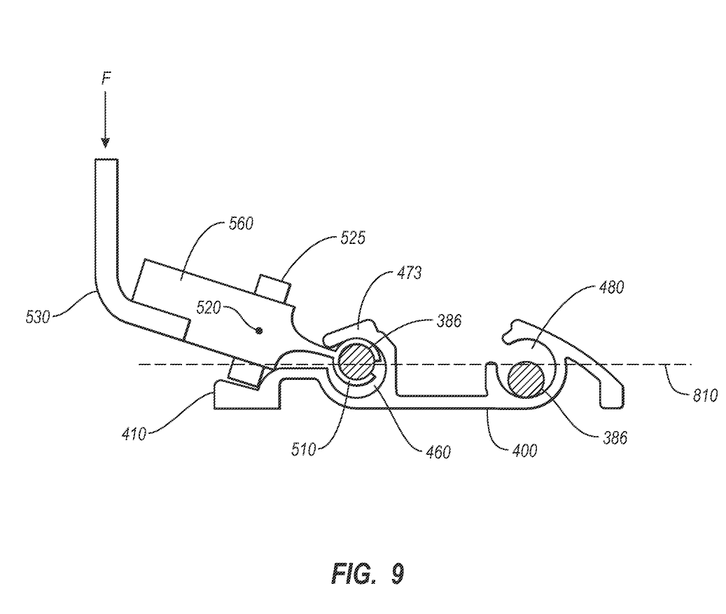

Furthermore, track 400 includes a support surface 410 that provides support to a support means on trolley 600. In particular, support means is configured for contact with support surface 410. For example, as shown in FIG. 3 support means in trolley 600 includes at least one wheel 525 that has an outside perimeter that is positioned for contact with the support surface 410 of track 400 when trolley 600 is received in slot 460. As will be described below in further detail in FIG. 9, the teeter-totter forces exerted on trolley 600 around the fulcrum wheel 525 act to lift slide 510 up away from the bottom of inner surface of slot 460 thereby avoiding much of the accumulated debris and buildup causing friction within slot 460 as the slide 510 moves along track 460. In addition, the wheel 525 acts to further reduce the total friction inhibiting movement of trolley 600 since the rolling motion of wheel 525 reduces the friction between support means and the support surface 410. In particular, the rolling friction between wheel 525 and the support surface 410 is less than the sliding friction between a support means that includes a sliding surface and the support surface.

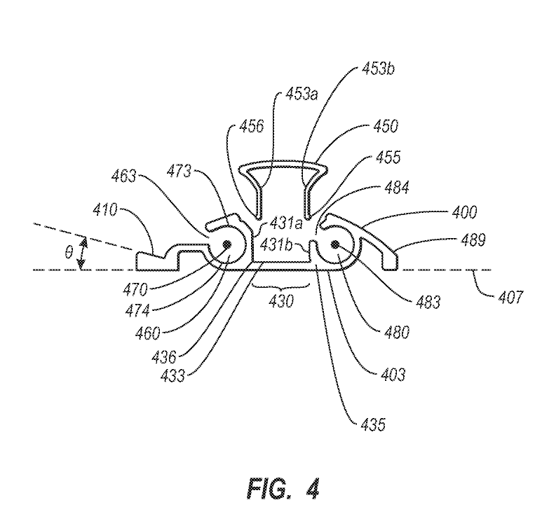

FIG. 4 illustrates a cross-sectional view of track 400 and snap-top decorative cap 450, in accordance with one embodiment of the present invention. As previously described, track 400 is configured to reduce the friction involved with extending and retrieving a cover over a space. As shown, track 400 includes slot 460 that is configured for slidably receiving outside edge 388 of cover 310 of FIG. 2. In addition, slot 460 is configured for slidably receiving the slide 510 of trolley 600. In particular, opening 463 is selected to allow for the unrestricted movement of connecting piece 561 of trolley 600 that is attached to slide 510, while the slide 510 is located within slot 460. Moreover, opening 463 is configured such that the outside edge 388 and the slide 510 are held within the slot 460 preventing their lateral escape, yet not hindering their longitudinal movement through slot 460.

Slot 460 also includes axis 470 which is substantially linear throughout the length of track 400. As shown, axis 470 is placed at the center of slot 460. In addition, track 400 also includes an opposing slot 480 that is laterally spaced from the slot 460. Opposing slot 480 extends the length 490 of track 400 and is configured to return the rope 386 that is attached to the outside edge 388 to a driving means used for extending and retrieving the cover 310 over the space. For example, turning now back to FIG. 3, rope 386 is directed through slot 460 to the distal end 496 of track 400 whereupon rope 386 is passed through a guide means, such as a pulley. Thereafter, rope 386 is trained around guide means and returned to track 400 through slot 480 at distal end 496. Rope 386 is directed through slot 480 to the front end 494 which leads to reel means, and motor means used for extending and retrieving cover 310 over the space.

Opposing slot 480 includes an opposing axis 483 that is substantially linear and runs substantially in parallel to axis 470 in slot 460. Axis 483 is placed at the center of slot 480. A horizontal plane that intersects with both axis 470 and axis 483 can be defined. The horizontal plane is substantially in parallel with the bottom surface 403 of track 400. In addition, slot 460 has an interior surface defined in part by axis 470. Upper portion 473 of the interior surface is located above axis 470 and above the horizontal plane intersecting axis 470 and axis 483. Also, the lower portion 474 of the interior surface can be located below axis 470 and below the horizontal plane intersecting axis 470 and axis 483.

As shown in FIG. 4, slot 480 has an opening 484 that has the same general orientation as the opening 463 of slot 460. That is, both openings 463 and 484 open towards lip 410, and is positioned generally above the axis 470 and 480, respectively. In particular, opening 484 opens inwards towards trough 430. When decorative cap 450 is fixed in trough 430, opening 484 is covered and sealed off from the environment, which keeps debris (e.g., leaves, dirt, etc.) from entering into slot 480 and fouling the operation of the returning rope means 386. However, it is envisioned that the opening 484 in slot 480 may open in a direction different from slot 460, or that slot 480 may not include opening 484.

As an added benefit, orienting the opening 484 of slot 480 inwards towards trough 430 facilitates the insertion of rope means 386 within slot 480. In particular, access to slot 480 is provided by removing cover piece 450, which facilitates replacement of rope means 386 after installation of the original cover 312 and its corresponding rope means 312, without removal or loosening of track 400 from the surface of the deck.

In addition, track 400 includes arm 489 both for purposes of visual decoration and lateral stability since arm 489 extends to line 407 to connect with the surface surrounding the space to be covered when track 400 is installed. However, other embodiments are well suited to track 400 without arm 489 so that the convex outer surface of slot 480 is exposed.

Over time, debris is accumulated within slot 460 and includes dirt, standing water, corrosion, and wearable material generated from the movement of the rope 386 through the slot 460. This accumulated debris contributes to the friction forces restricting movement of the outside edge 388 and slide 510 of trolley 600 through slot 460. However, as will be described more fully below in relation to FIG. 9, embodiments of the present invention are capable of lifting the slide 510 above the lower portion 474 towards the upper portion 473 of slot 460 to reduce the friction forces contributing to the jerking motion exhibited when extending or retrieving cover 310.

Track 400 also includes support surface, shown as lip 410. Lip 410 is attached to and protrudes from track 400 proximate the slot 460 but opposite the opposing slot 480, and extends the length 490 of track 400. More particularly, lip 410 protrudes outwardly towards the outside edge 312 of cover 310 when the trolley 600 is positioned above lip 410. In general, support surface is configured so as to provide support for the trolley 600 when support means of the trolley 600 is positioned over the support surface. For example, lip 410 is configured so as to provide support for wheels 525 and 526 in trolley 600 when the trolley 600 is positioned over lip 410 such that slide 510 is received in slot 460.

In one embodiment, lip 410 is positioned by an angle θ from line 407. Angled lip 410 is configured to compensate for a downward force exerted on the trolley 600 by the weight of the leading edge support 580 and cover 312 when the trolley 600 is positioned on lip 410. In particular, the angle θ of lip 417 counteracts the downward sag exhibited by the weight of the leading edge support 580, and prevents the leading edge support 580 from dragging across the surface of the pool as the cover 310 is extended and retrieved over the pool surface.

In addition, lip 410 provides an even surface for supporting trolley 600, and more specifically for supporting wheels 525 and 526 of trolley 600 throughout the length 490 of track 400. As such, lip 410 provides a consistent support pressure on wheels 525 and 526 to facilitate the extension and retrieval of cover 312 over the pool surface, for example. In addition, lip 410 maintains a consistent positional relationship between wheels 525 and 526 and trolley 600 to the slot 460 at any position along track 400, even if the deck supporting track 400 is uneven or broken, such as is the case with decks made from concrete, brick, or stone. This consistent support pressure and consistent positional relationship greatly facilitates movement of trolley 600 throughout the length of track 400 as cover 312 is extended or retrieved over a system that includes a trolley mechanism that may use the deck as a support instead of using a lip 410, as in embodiments of the present invention.

The combination of slot 460 and slot 480 is configured to form trough 430. Trough 430 includes sidewall 431 which is associated with the outer surface of slot 460, and sidewall 432, which is associated with outer surface of slot 480. In addition, trough 430 includes a bottom surface 430. Trough 430 is configured to extend the length 490 of track 400. As described previously, trough 430 is of sufficient width and depth to accept a fastener, such as screw 329 that is intended to fasten track 400 to the surface surrounding the space to be covered. For example, screw 329 can be drilled down through the center of bottom surface 430 such that the head of the screw 329 is positioned within the well of trough 430 formed by sidewalls 431 and 432.

Decorative cap 450 is configured to fit within trough 430. In particular, decorative cap 450 includes opposing concave side walls 453a and 453b that correspond to the convex shaped sidewalls 431a and 431b of track 400, when the decorative cap 450 is inserted into trough 430. In one embodiment, decorative cap 450 is designed to snap and lock into grooves 435 and 436 that are cut into the bottom of trough 430. For instance, protrusions 456 and 455 snap into grooves or snap catches 435 and 436, respectively. Also, the two sidewalls 431a and 431b are of sufficient length and configured to act as springs that hold the decorative cap within trough 430, but is also configured for removal to enable access slot 480 and the fasteners (e.g., screws) used to affix the track 400 to a surface. The purpose of decorative cap 450 is to hide the fasteners (e.g., fastener 329) that are installed in the trough 430 when attaching the track 400 to the surface surrounding the space to be covered.

In addition, decorative cap 450 accentuates the visual appearance of track 400 by providing a smooth top surface to track 400 that is devoid of any openings or protrusions. That is, holes and tops of fasteners are not shown, as in previous track systems. As a result, the top surface of track 400 provides a smooth surface for walking, and feet or other exposed body parts will no longer catch on exposed tops of fasteners since they are hidden.

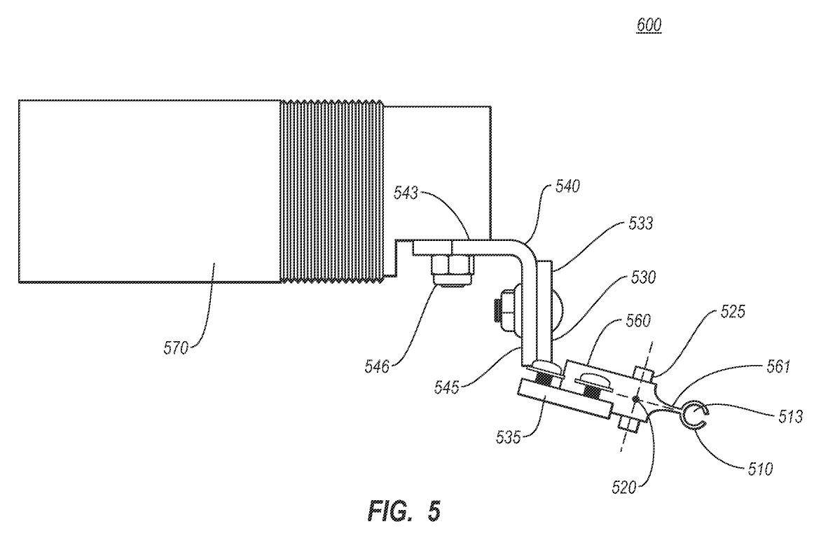

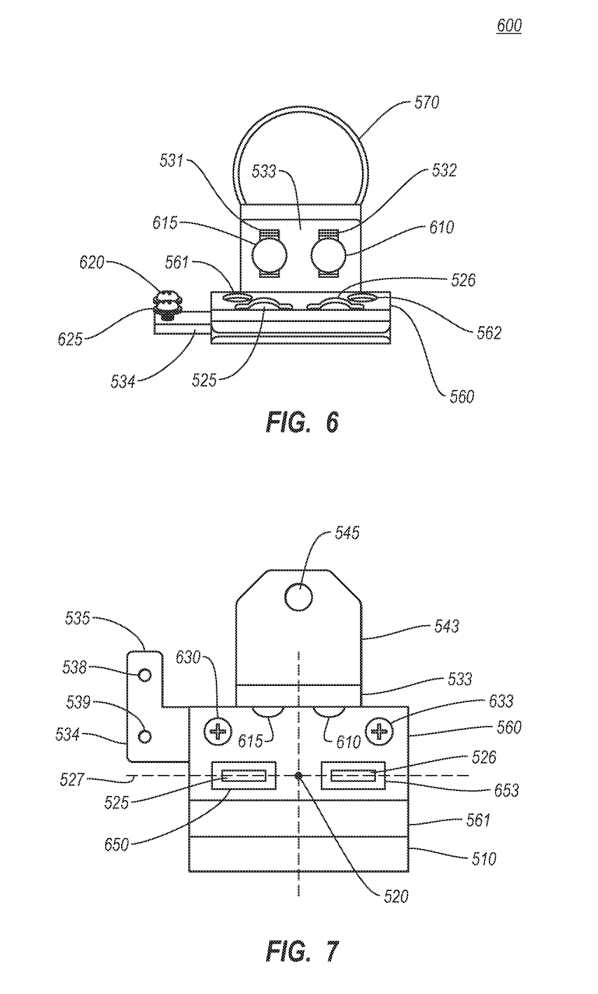

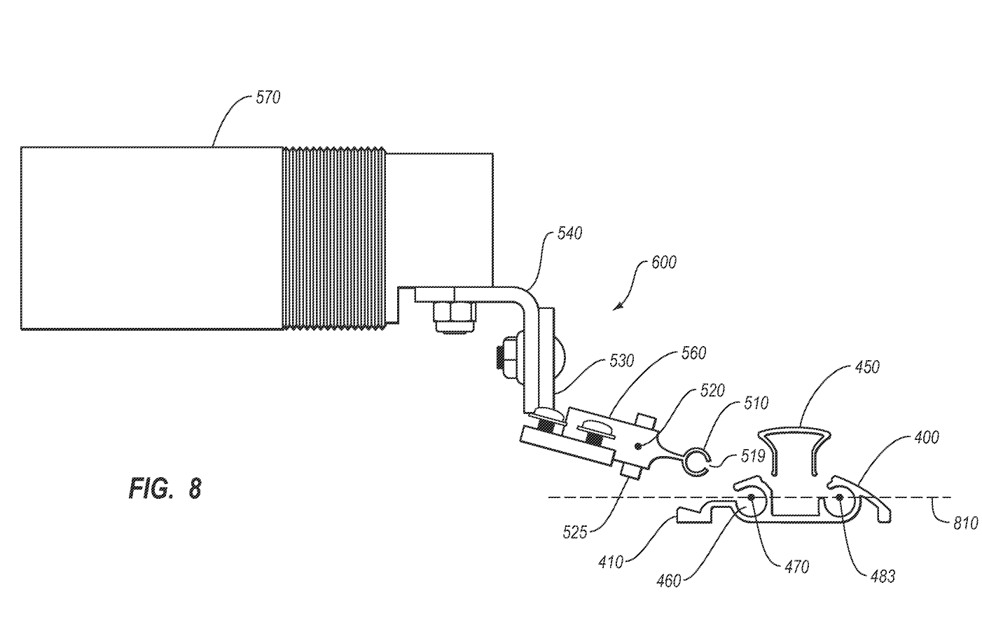

Turning now to FIGS. 5-7, a trolley 600 is shown for attaching the leading edge of a cover to a track, in accordance with embodiments of the present invention. in particular, FIG. 5 is a side view depiction of trolley 600, FIG. 6 is a side view depiction of trolley 600, and FIG. 7 is a top view depiction of trolley 600. For example, trolley 600 can be used to attach the leading edge support 580 to track 400 to facilitate extending and retrieving cover 310 over the space to be covered.

Trolley 600 includes support extension 570 that acts as a cover bar attachment. In particular, as described previously, support extension 570 may be inserted into the leading edge support 580, examples of which include a cylindrical cover bar, to adjustably connect the leading edge support 580 to the trolley 600. In that way, leading edge support 580 is moveable with trolley 600 along track 400 to facilitate the extension and retrieval of cover 310. In other embodiments, trolley 600 need not include support extension 570 and is directly connected to the leading edge support 580. In that way, the leading edge support 580 extends directly between the two trolleys associated with the two parallel tracks extending proximate to the space to be covered.

More particularly, trolley 600 includes a connecting structure which connects the slide 510 to the support extension 570, or directly to the leading edge support 580, as previously described in other embodiments of the present invention. The connecting structure includes a bracket system and an arm 560. As shown in FIGS. 5-7, bracket system includes bracket 540 and bracket 530 which are adjustable in relation to each other to increase height of the bracket system. Other embodiments are well suited to a bracket system that is comprised of one piece.

Bracket 540 is a “L” shaped bracket with a base plate 543 and an extension plate 545. Base plate 543 includes an aperture 545 to receive a screw or bolt 546, or any other type of fastening means, to secure base plate to the support extension 570, or directly to leading edge support 580. Extension plate 545 includes elongated slots (not shown) to receive bolts 615 and 610, which attach extension plate 545 to extension plate 533.

Bracket 530 is an angled bracket with base plate 534 and extension plate 533. Extension plate 533 includes elongated slots 531 and 532 to receive bolts 615 and 610, respectively so that bracket system may be adjusted to increase the vertical height the support extension 570 is displaced from track 400, for example. In one embodiment, bolts 615 and 610 are made of stainless steel to resist corrosion. In this manner, in the case where cover 310 is covering a pool, the leading edge support 580 is further displaced from the surface of the water in the pool which helps to reduce the surface tension forces of the water on the cover 310 that act to hinder the extension and retrieval of cover 310 over the pool. In addition, the size of elongated slots 531 and 532 and corresponding slots within extension plate 545 are such to allow for rotational displacement of extension plate 545 in relation to extension plate 533. In that way, leading edge support 580 may be angled to compensate for rotational forces that may be present. The base plate 534 is configured to attach to arm 560, which includes apertures (not shown) to receive screws 630 and 633, or other fastening means. Base plate also has a tab 535 which includes apertures 538 and 539 to receive bolts or screws, or other securing means for purposes of securing the tab 535 to cover 310, which aids in reducing the forces on the leading edge 312 of cover 310 when extending and retrieving cover 310 over the space to be covered.

Trolley 600 also includes arm 560. Arm 560 includes apertures 561 and 562 to receive screws 630 and 633 respectively for attaching arm 560 to base plate 534, and in turn to bracket 530. Arm 540 can be made of plastic-like material, in one embodiment, such as a nylon based material. In addition, arm 560 includes elongated slots 650 and 653 that is configured to retain and hold respective wheels 525 and 526 through corresponding axis (not shown). Wheels 525 and 526 are made of a plastic-like material, in one embodiment, such as a high molecular weight plastic. Wheels 525 and 526 in conjunction with arm 560 act as support means and are positioned to roll on a support surface (e.g., lip 410) so that trolley 600 is fully supported on track 400. The support surface, such as lip 410, is sized and configured to facilitate movement of the wheels 525 and 526. In particular, when the slide 510 is positioned within slot 460 such that trolley 600 is positioned over lip 410, wheels 525 and 526 are supported by lip 410 and roll along lip 410, which acts to reduce the friction involved within slot 460 as the cover 310 is extended and retrieved over the space to be covered. Other embodiments are well suited to varying the number of wheels located within the arm 560, such as an arm 560 including one wheel, arm 560 including more than two wheels, etc. Still other embodiments are well suited to include other means for support to include roller bearings, or sliding surfaces that interface with lip 410 of track 400. Also, arm 560 includes a bridge 561 that extends to slide 510. Bridge 561 is configured to be of a thickness to be slidingly received by opening 463 to facilitate the movement of trolley 600 along track 400 when slide 510 is positioned within slot 460.

Arm 560 and trolley 600 includes a center 520 through which the supporting force is directed when wheels 525 and 526 are positioned on lip 410. Although most of the supporting forces are directed through wheels 525 and 526, center 520 is representative of the supporting forces acting on arm 560, such as the substantially downward force placed on trolley 600 and arm 560 due to the weight of the leading edge support 580, and the compensating upward force exerted on the trolley 600 and arm 560 through wheels 525 and 526 from the lip 410. Center 520 is located between wheels 525 and 526 along line 527 and approximately centered within thickness of the arm 560. As is more clearly shown in FIGS. 8 and 9, the center 520 is positioned above axis 470 when the wheels 525 and 526, as support means, are positioned on or over lip 410, as a supporting surface, and more particularly, when slide 510 is slidingly received by slot 460. That is, each of the wheels 525 and 526 are sized to have a corresponding perimeter to be in contact with lip 410, as a support surface, when trolley 600 is attached to track 400, such that center 420 is positioned above axis 470. As shown in FIG. 6, the diameters of the wheels 525 and 526 are such that a corresponding perimeter extends beyond at least the lower surface of arm 560 to facilitate contact with support surface 410. In addition, wheels 525 and 526 can be made of any material suitable for durability, and rolling, such as plastic, or metal, etc.

Slide 510 is also shown in FIGS. 5-7 and includes a slot 513 with opening 519 for firmly affixing to a rope means (e.g., rope 386) or any other suitable means for purposes of extending and retrieving cover 310 across a space to be covered. The inside diameter of slide 510 and opening 519 are configured to fixedly surround the rope means, for example through compression. The outside diameter of the slide 510 is smaller than the diameter of slot 460 so that slide 510 can be slidingly received within slot 460 to facilitate movement of slide 510 within slot 460, and in turn trolley 600 along track 400 as the cover 310 is extended and retrieved.

FIG. 8 is a side view of the trolley 600 and track 400 in relative positions such that slide 510 attached to trolley 600 is ready to be received by slot 460 of track 400, in accordance with one embodiment of the present invention. When slide 510 is slidingly received by track 460, trolley 600 is positioned such that wheels 525 and 526 are supported by lip 410. As described previously in relation to FIG. 4, lip 410 is angled by angle θ to compensate for a downward force placed on the support means for trolley 600 which include wheels 525 and 526 and arm 560 due to the weight of the leading edge support 580 that is attached to the cover 310. In addition, bracket 530 may also be angled to compensate for angle θ, such that the inner angle between the base plate 534 and extension plate 533 is 90° plus angle θ. In that way, the surface of the perimeter of wheels 525 and 526 are matched to the surface of lip 410 for maximum contact. Other embodiments are well suited to an inner angle for bracket 530 that are slightly greater than 90° plus angle θ.

In addition, when slide 510 is slidingly received by slot 470, center 520 is positioned above axis 470, and more particularly, above the horizontal plane defined by line 810 which intersects both axis 470 and axis 483. That is, center 520 will always be above the horizontal plane even with the downward forces applied to trolley 600 by the leading edge support 580 through support extension 570. Having the center 520 above the horizontal plane defined by line 810 compensates for the downward force exerted on the wheels 525 and 526 due to the sagging of the leading edge support 580.

In FIG. 9, the relationship between the trolley 600 and track 400 is more clearly shown when slide 510 is slidingly received by slot 460, and wheel 525 is positioned on lip 410. A downward force “F” is shown applied to bracket 530 which is translated to arm 560 and represents the force applied to the trolley 600 due to the weight of the leading edge support 580. As shown, lip 410 acts as a fulcrum supporting the teeter-totter forces applied to the arm 560 and slide 510. In particular, as force “F” is applied to bracket 530, the fulcrum action of the lip on wheel 525 acts to rotate slide 510 towards the upper portion 473 of the interior surface of slot 460. Increasing the distance between slide 510 and wheels 525 and 526, and correspondingly center 520, moves the fulcrum out further from slide 510 and closer to the translated force F through bracket 530, thereby reducing the mechanical advantage of the force F applied on the lever arm 560. This ultimately decreases the corresponding force that is applied by the upper portion 473 to keep slide 510 from rotating out of slot 510. As such, the static forces applied to the bracket 530, arm 560, and slide 510 act to maintain a constant relative position of slide 510 to slot 460, and in turn, maintain a constant relative position of trolley 600 with the slot 460 of track 400.

In addition, as shown in FIG. 9, because of the teeter-totter forces applied to arm 560, slide 510 is rotated upwards and away from the bottom portion 474 of slot 460. Debris from dirt, water, corrosion, among others, form and collect on bottom portion 474. By rotating slide 510 away from the debris, friction forces from slot 460 that act to inhibit the movement of rope 386 through slots 460 and 480 are reduced. In particular, as described above, the friction forces associated with slot 460 from slide 510 are greatly reduced due to the action of the fulcrum provided from wheels 525 and 526. These friction forces are further reduced by increasing the distance between wheels 525 and 526 and slide 510. That is, the translated force exerted on upper portion 473 of the interior surface of slot 460 by slide 510 is reduced, thereby reducing the friction forces between slot 460 and slide 510. Further, the friction forces between slot 460 and slide 510 illustrated in FIG. 9 are greatly reduced in comparison to an arm that does not include the benefit of a support means that interacts with a support surface (e.g., lip 410), since a greater fulcrum force would be concentrated on bridge 561 and the bottom of opening 519 on slot 513, thereby increasing the friction forces between slot 460 and slide 510. Rope 386 is shown returning in slot 480 and is attached to a driving means used for extending and retrieving cover 310.

Accordingly, embodiments of the present invention provide for an improved track system that provides for reduced friction when extending and retrieving a cover over a space, and a snap-top decorative cap to hide fasteners used to attach the track to a surface surrounding the space.

An improved track system with supporting lip and snap-top decorative cap, is thus described. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments, but rather construed according to the below claims.

What is claimed:

1. A track system for use with a cover positionable over a space, said track system comprising:
a first track positioned proximate said space, said first track having a first slot extending the length of said first track, said first slot of said first track being configured for slidably receiving a first outside edge of said cover;
a second track in alignment with said first track and positioned proximate said space and with said space between said first track and said second track, said second track having a second slot extending the length of said second track, said second slot of said second track being configured for slidably receiving a second outside edge of said cover, said second outside edge being opposite to and in general alignment with said first outside edge of said cover;
a first trolley having a first slide for positioning in and configured for movement in said first slot, said first trolley having first support means for contact with a first support surface to support said first trolley, said first support means being configured to facilitate movement of said first trolley relative to said first track;
a second trolley having a second slide for positioning in and configured for movement in said second slot, said second trolley having second support means for contact with a second support surface to support said second trolley, said second support means being configured to facilitate movement of said second trolley relative to said second track; and
a leading edge support for connection to and between said first trolley and said second trolley, said leading edge support being configured to have a leading edge of said cover attached thereto, said leading edge support being movable with said first trolley and said second trolley to between a first position in which said cover is positioned toward covering said space and a second position different from said first position and toward uncovering said space.

2. The track system of claim 1 wherein said first trolley has a first connecting structure for connecting said first slide to said leading edge support; and wherein said second trolley has a second connecting structure for connecting said second slide to said leading edge support.

3. The track system of claim 2 wherein said first support means is associated with said first connecting structure, wherein said first support means has a first center through which first supporting force is directed when said first support means is positioned on said first support surface, wherein said first slot has a first axis that is substantially linear, and wherein said first support means is arranged on said first connecting structure such that said first center is positioned above said first axis when said first support means is positioned on said first support surface, wherein said second support means is associated with said second connecting structure, wherein said second support means has a second center through which second supporting force is directed when said second support means is positioned on said second support surface, wherein said second slot has a second axis that is substantially linear, and wherein said second support means is arranged on said second connecting structure such that said second center is positioned above said second axis when said second support means is positioned on said second support surface.

4. The track system of claim 3 wherein said first support means includes a first wheel sized to have a corresponding perimeter in contact with said first support surface such that said first center is above said first axis when said first support means is positioned on said first support surface; and wherein said second support means includes a second wheel sized to have a corresponding perimeter in contact with said second support surface such that said second center is above said second axis when said second support means is positioned on said second support surface.

5. The track system of claim 3, wherein said first support means includes a first plurality of wheels each sized to have a corresponding perimeter in contact with said first support surface such that said first center is above said first axis when said first support means is positioned on said first support surface; and wherein said second support means includes a second plurality of wheels each sized to have a corresponding perimeter in contact with said second support surface such that said second center is above said second axis when said second support means is positioned on said second support surface.

6. The track system of claim 3 wherein said first support surface is a first lip attached to and protruding outwardly from said first track proximate said first slot and extending the length of said first track, wherein said first lip is sized and configured for said first support means to move thereon; and wherein said second support surface is a second lip attached to and protruding outwardly from said second track proximate said second slot and extending the length of said second track, wherein said second lip is sized and configured for said second support means to move thereon.

7. The track system of claim 6, wherein said first lip being configured to protrude outwardly towards said first outside edge of said cover when attached and angled to compensate for a first downward force on said first support means due to the weight of said leading edge support attached to said cover when said first support means is positioned on said first support surface; and wherein said second lip being configured to protrude outwardly towards said second outside edge of said cover when attached and angled to compensate for a second downward force on said second support means due to the weight of said leading edge support attached to said cover when said second support means is positioned on said second support surface

8. The track system of claim 3, wherein said first track includes a first opposing slot laterally spaced from said first slot and extending the length of said first track, said first opposing slot being configured to return a first rope means associated with said first outside edge of said cover being guided through said first slot to a driving means used for extending and retrieving said cover, wherein said first opposing slot includes a first opposing axis that is substantially linear, wherein said first slot is associated with a first horizontal plane including said first axis and said first opposing axis, wherein said first center is positioned above said first horizontal plane when said first support means is positioned on said first support surface; and wherein said second track includes a second opposing slot laterally spaced from said second slot and extending the length of said second track, said second opposing slot being configured to return a second rope means associated with said second outside edge of said cover being guided through said second slot to said driving means used for extending and retrieving said cover, wherein said second opposing slot includes a second opposing axis that is substantially linear, wherein said second slot is associated with a second horizontal plane including said second axis and said second opposing axis, wherein said second center is positioned above said second horizontal plane when said second support means is positioned on said second support surface

9. The track system of claim 3 wherein said first support means being configured to cause said slider to rotate towards a top portion of an inner surface of said first slot when a downward force is applied on said first support means due to the weight of said leading edge support attached to said cover when said first support means is positioned on said first support surface; and wherein said second support means being configured to cause said slider to rotate towards a top portion of an inner surface of said second slot when a downward force is applied on said second support means due to the weight of said leading edge support attached to said cover when said second support means is positioned on said second support surface

10. The track system of claim 3 wherein said first track includes a first opposing slot laterally spaced from said first slot and extending the length of said first track, said first opposing slot being configured to receive a first rope means through a first opening oriented towards a first trough, and to return said first rope means associated with said first outside edge of said cover being guided through said first slot to a driving means used for extending and retrieving said cover, said first trough being configured between said first slot and said first opposing slot, wherein said first trough extending the length of said first track and being configured to receive means for attaching said first track to a first walking surface, and a first cover piece removably positioned over said first trough, said cover piece extending the length of said first track; and wherein said second track includes a second opposing slot laterally spaced from said second slot and extending the length of said second track, said second opposing slot being configured to receive a second rope means through a second opening oriented towards a second trough, and to return said second rope means associated with said second outside edge of said cover being guided through said second slot to said driving means, said second trough being configured between said second slot and said second opposing slot, said second trough extending the length of said second track and configured to receive means for attaching said second track to a second walking surface, and a second cover piece removably positioned over said second trough, said second cover piece extending the length of said second track.

11. A track system for use with a cover positionable over a space, said track system including a track positioned proximate said space, said track comprising:
a slot extending the length of said track, said slot being configured for slidably receiving an outside edge of said cover;
an opposing slot laterally spaced from said first slot and extending the length of said track, said opposing slot being configured to return a rope means associated with said outside edge of said cover being guided through said slot to a driving means used for extending and retrieving said cover, wherein said opposing slot is configured to receive said rope means through an opening oriented towards said first slot;
a trough being configured between said slot and said opposing slot, wherein said trough extending the length of said first track and being configured to receive means for attaching said track to a walking surface; and
a cover piece removably positioned over said trough, said cover piece extending the length of said track.

12. The track system of claim 11, wherein said track further comprises a support surface configured to support a trolley having a slide for positioning in and configured for movement in said slot, said trolley including a support means for contact with said support surface and configured to facilitate movement of said trolley relative to said track when said support means is positioned on said support surface.

13. The track system of claim 12, wherein said support surface comprises a lip attached to and protruding outwardly from said track proximate said slot and extending the length of said track, wherein said lip is sized and configured for support means to move thereon.

14. The track system of claim 13, wherein said lip being configured to protrude outwardly towards said outside edge of said cover when attached and angled to compensate for a downward force applied on said support means due to the weight of a leading edge support attached to said cover and to said trolley, wherein said downward force applied when said support means is positioned on said support surface.

15. The track system of claim 11, wherein said track further comprises:
a cover piece removably positioned over said trough, said cover piece extending the length of said track.

16. A track system for use with a cover positionable over a space, said track system including a trolley for use with a cover positionable over a space, said trolley comprising:
a slide for positioning in and configured for movement in a slot extending the length of an associated track, said slot being also configured for slidably receiving an outside edge of said cover; and
a connecting structure having one end configured for connecting to a leading edge support being configured to have a leading edge of said cover attached thereto and an opposing end configured for connecting to said slide, wherein said connecting structure includes a support means for contact with a support surface of said track, said support means being configured to facilitate movement of said trolley relative to said track when said support means is positioned over said support surface, and wherein said support means being configured to cause said slide to rotate towards a top portion of an inner surface of said slot about a contact point between said support means and said support surface due to the weight of said leading edge support attached to said cover when said first support means is positioned on said first support surface.

17. The track system of claim 16, wherein said connecting structure further comprises an adjustable bracket structure connecting said slide to said leading edge support.

18. The track system of claim 16, wherein said support means has a center through which supporting force is directed when said support means is positioned on said support surface, wherein said center is arranged on said connecting structure such that said first center is positioned above a first axis associated with said slot that is substantially linear when said support means is positioned on said support surface.

19. The track system of claim 18, wherein said support means includes a wheel sized to have a corresponding perimeter in contact with said support surface.

20. The tracks system of claim 18, wherein said support means includes a plurality of wheels each having a corresponding perimeter in contact with said support surface.

21. The track system of claim 18, wherein said first support means includes a roller bearing mechanism configured to come into contact with said support surface.

22. The track system of claim 18, wherein said support means includes a sliding surface configured to come into contact with said first support surface.
